(19) United States
(12) Patent Application Publication
(10) Pub. No.: US 2018/0086780 A1
(43) Pub. Date: Mar. 29, 2018

(54) METHOD OF PRODUCTION OF N,N-BIS(2-CHLOROETHYL)TETRAHYDRO-2H-1,3,2-OXAZAPHOSPHORINE-2-AMINE 2-OXIDE

(71) Applicant: PRZEDSIEBIORSTWO PRODUKCY JNO-WDROZENIOWE IFOTAM Sp. z o.o., Lódz (PL)

(72) Inventors: Bogdan UZNANSKI, Lódz (PL); Tomasz DYMITRUK, Lódz (PL)

(73) Assignee: PRZEDSIEBIORSTWO PRODUKCYJNO-WDROZENIOWE IFOTAM Sp. z o.o., Lódz (PL)

(21) Appl. No.: 15/562,655

(22) PCT Filed: Apr. 2, 2015
(86) PCT No.: PCT/IB2015/052452

§ 371 Date: Sep. 28, 2017

(51) Int. Cl. C07F 9/6584; C07B 47/00; B01D 9/00

(52) U.S. Cl. CPC C07F 9/65846; B01D 9/0018; C07B 47/00

(57) ABSTRACT

The invention relates to a method of production of N,N-bis(2-chloroethyl)amino)-2-oxo-1,3,2-oxazaphosphorinane in a reaction of phosphorous oxychloride POCl₃, N,N-bis(2-chloroethyl)amine, and 3-aminopropan-1-ol in a single reaction vessel, characterized by the fact that phosphorous oxychloride and N,N-bis(2-chloroethyl)amine hydrochloride are added to an inert aprotic organic solvent placed in a closed reaction vessel, in a slight molar excess in relation to phosphorous oxychloride, whereupon the mixture is cooled to temperature in the range of −15 to −10° C., and with the temperature maintained within this range and continuous stirring, the solution of 3-aminopropan-1-ol and the first portion of the auxiliary base is slowly added in an amount of 1 mole calculated as per 1 mole of 3-aminopropan-1-ol in an inert aprotic organic solvent, and subsequently, while maintaining the reaction mixture temperature in the range of −7 to −3° C. the second portion of the auxiliary base is added dropwise, in an amount required for binding of HCl released during the cyclisation reaction, and after the mixture reaches temperature in the range of 15 to 20° C. it is stirred in this temperature for a period of 5 to 25 hours, whereupon, while continuously stirring, the remaining portion of the auxiliary base is added dropwise, in an amount of 2-2.3 moles, calculated per a theoretical amount of hydrochloride released from bis(2-chloroethyl)amine hydrochloride and released in the reaction of substitution of chlorine at the phosphorous atom in 2-chloro-tetrahydro-2H-1,3,2-oxazaphosphorine 2-oxide, and without stopping the stirring, the temperature is gradually increased from 20 to 40° C., the reaction being conducted until the conversion of the substrates is complete.

### TECHNICAL FIELD

The object of the invention is a method of production of N,N-bis(2-chloroethyl)-tetrahydro-2H-1,3,2-oxazaphosphorine-2-amine 2-oxide of pharmacopoeial purity, in a single reaction vessel.

N,N-bis(2-chloroethyl)-tetrahydro-2H-1,3,2-oxazaphosphorine-2-amine 2-oxide is a substance with anti-cancer, immunosuppressive and anti-inflammatory activity, known under its international unregistered (INN) name cyclophosphamide.

### BACKGROUND ART

Compounds containing a 1,3,2-oxazaphosphorinane ring in their structure, as well as 2-chloroethylamide functional groups, chemically representing nitrogen mustard derivatives, have been known since the 60s in the XX century as cytostatic alkylating drugs. These include inter alia derivatives described in U.S. Pat. No. 3,018,302, such as 2-bis[(2-chloroethyl)amino]-2-oxo-1,3,2-oxazaphosphorinane (other names: N,N-bis(2-chloroethyl)-1,3,2-oxazaphosphorine-2-amine 2-oxide, or according to IUPAC terminology—N,N-bis(2-chloroethyl)-2-oxo-1,3,2λ⁵-oxazaphosphinan-2-amine) known as cyclophosphamide and its structural isomer, N,3-bis(2-chloroethyl)-tetrahydro-2H-1,3,2-oxazaphosphorine-2-amine 2-oxide, namely ifosfamide. They are prodrugs which are activated under the influence of cytochrome P450, mainly in the liver, by means of hydroxylation of a carbon atom in the ring in the C-4 position. Cyclophosphamide and ifosfamide active metabolites, formed as a result of spontaneous reactions cascade, due to having 2-chloroethylamide groups, exhibit cytotoxic activity resulting from bis-alkylation complementary DNA strands in the nucleus. Apart from ifosfamide and cyclophosphamide, a significant role in anti-cancer therapy is played by their less toxic analogue for oral administration—trofosfamide (N,N,3-tris(2-chloroethyl)-tetrahydro-2H-1,3,2-oxazaphosphorine-2-amine 2-oxide), whose main metabolite is ifosfamide [C. Blomqvist et al., Cancer Chemother Pharmacol (1995), 36: 263-265].

A comprehensive discussion on oxazaphosphorinane drugs research, metabolism thereof and a review of research and development directions may be found e.g. in the publication of K. Misiura, Post [symbol] py Hig Med. Dosw (online), 2004; vol. 58; 463-471.

Even though a variety of newer anti-cancer drugs have been introduced to therapy, 1,3,2-oxazaphosphorinanes still have an important position among cytostatic drugs with alkylating activity.

Accordingly, more effective and safer methods of producing thereof are continuously being investigated.

Of several possible methods of 1,3,2-oxazaphosphorinane derivatives synthesis, two have gained practical significance.

In the first one, developed by the Asta company and known as the German method, described inter alia in U.S. Pat. No. 3,018,302, N,N-bis(2-chloroethyl)amine hydrochloride is subjected to phosphorylation in a reaction with phosphorous oxychloride in the presence of a base binding the hydrochloride released from the ammonium salt, in an inert solvent. The obtained N,N-bis(2-chloroethyl)phosphoramide dichloride is subjected to cyclocondensation with 3-aminopropan-1-ol, in the presence of a base binding the released hydrochloride, yielding cyclophosphamide.

In the second approach, developed by Laake Oy, also known as the Finnish method, described in GB patent specification 1,235,022 and J. Org. Chem. 26 (1961), 4743, cyclophosphamide is obtained in a reaction of substitution of chlorine at the phosphorous atom of cyclic amido chlorophosphate (2-chloro-tetrahydro-2H-1,3,2-oxazaphosphorine 2-oxide) with an equimolar amount of N,N-bis(2-chloroethyl)amine in an inert solvent, such as methylene chloride, in the presence of 2 moles of triethylamine as a binding agent for hydrochloric acid, and subsequently the formed triethylamine hydrochloride and the solvent are removed from the reaction medium, with the addition of water to separate cyclophosphamide in the form of a monohydrate.

The described methods are characterized by low yields and low accessibility of substrates for the reaction, resulting from their low thermal and hydrolytic stability.

Conducting synthesis in several steps requires dehermetization of the equipment and the addition of hazardous 2-chloroethylamine derivatives, which also causes an increase in the danger of cross-contamination.

Furthermore, separation and purification of intermediates requires contact with toxic chemicals at every step of the process, increasing both health risks for the manufacturing personnel and risk of contaminating the reaction mixture with undesired substances during production. Additionally, the separation process is conducted using inflammable solvents, e.g. diethyl ether, with low boiling points, posing a risk of explosion or fire and of being life-threatening.

The solution to a part of the abovementioned problems was shown in patent specification PL 190097 B1, wherein the process of production of 1,3,2-oxazaphosphorinane derivatives, including cyclophosphamide, is realized as a two-step reaction of phosphoryl halide and two amines in one reactor. It does not require separation of intermediates nor their purification and is conducted with minimization of influence of water and alcohol. The inventors declare a significant increase in synthesis efficiency in comparison to previous solutions.

In one of the examples, triethylamine is added dropwise to N,N-bis(2-chloroethyl)amine hydrochloride suspension in dichloromethane and in phosphorus oxychloride, in temperature of 0-10° C., in a slight molar excess in relation to N,N-bis(2-chloroethyl)amine. After 3 hours, a 3-aminopropan-1-ol mixture with a second triethylamine portion is added to the reactor, in temperature not exceeding 15° C. On the next day, after extraction with dichloromethane and its concentration, the product crystallized in diethyl ether with water-saturated activated carbon is filtered and dried.

Studies performed by the present inventors led to the conclusion that it is possible to realize the process of cyclophosphamide production, conducting a reaction of N,N-bis(2-chloroethyl)amine, phosphorous oxychloride and 3-aminopropan-1-ol in a single reaction vessel, controlling the course of the reaction and the order of substrate conversion with the temperature of the process and the speed of dripping of the auxiliary hydrochloride binding base.

### DESCRIPTION OF THE INVENTION

A method of production of (2RS)-N,N-bis(2-chloroethyl)-tetrahydro-2H-1,3,2-oxazaphosphorine-2-amine 2-oxide in a reaction of N,N-bis(2-chloroethyl)amine, phosphorous oxychloride POCl₃ and 3-aminopropan-1-ol in a single reaction vessel is characterized by the fact that phosphorous oxychloride and N,N-bis(2-chloroethyl)amine hydrochloride are added to an inert aprotic organic solvent placed in a closed reaction vessel, in a slight molar excess in relation to phosphorous oxychloride, whereupon the mixture is cooled to temperature in the range of −15 to −10° C., and with the temperature maintained within this range and continuous stirring, the solution of 3-aminopropan-1-ol and the first portion of the auxiliary base is slowly added in an amount of 1 mole calculated as per 1 mole of 3-aminopropan-1-ol in an inert aprotic organic solvent, and subsequently, while maintaining the reaction mixture temperature in the range of −7 to −3° C. the second portion of the auxiliary base is added dropwise (slowly), in an amount required for binding of HCl released during the cyclisation reaction, and after the mixture reaches temperature in the range of 15 to 20° C. it is stirred in this temperature for a period of 5 to 25 hours, whereupon, while continuously stirring, the remaining portion of the auxiliary base is added dropwise (slowly), in an amount of 2-2.3 moles, calculated per a theoretical amount of hydrochloride released from bis(2-chloroethyl)amine hydrochloride and released in the reaction of substitution of chlorine at the phosphorous atom in 2-chloro-tetrahydro-2H-1,3,2-oxazaphosphorine 2-oxide, and without stopping the stir, the temperature is gradually increased to from 20 to 40° C., the reaction being conducted until the conversion of the substrates.

The process is conducted in a hermetically sealed reactor and the addition of reagents is performed by means of a pump through a suitable pipeline.

As the inert aprotic organic solvent in the synthesis, for example tetrahydrofuran, dioxane, saturated hydrocarbons, chlorinated aliphatic and aromatic hydrocarbons, such as chloroform, dichloromethane, chlorobenzene are used. Particularly preferred solvent is chloroform.

The solvent used should not contain water, preferably a solvent containing no more than 0.01% water is used.

The process is conducted in a single reaction vessel, reaction speed and order of substrate conversion being controlled with the temperature of the process and the speed of dripping of the auxiliary base. The molar excess of the N,N-bis(2-chloroethyl)amine hydrochloride in relation to the 3-aminopropan-1-ol is preferably 1-5%.

The auxiliary base may be any aromatic or aliphatic tertiary amine, preferably trialkylamine, such as triethylamine.

The auxiliary base plays a triple role in the process according to the invention—it controls the speed of the cyclisation reaction to 2-chloro-2-oxo-1,3,2-oxazaphosporinane and of the substitution of the phosphate chlorine atom therein with N,N-bis(2-chloroethyl)amine, also controlling the speed of N,N-bis(2-chloroethyl)amine release from hydrochloride thereof and binding the hydrochloride released in these processes.

In contrast to the methods described in literature, wherein the cyclisation step goes through the formation of a hydroxypropylamide derivative with the subsequent closing of the ring in a reaction of substitution of a chlorine atom with a hydroxyl group, the present procedure changes the order of the cyclisation steps.

The postulated course of the reaction is shown in scheme 1.

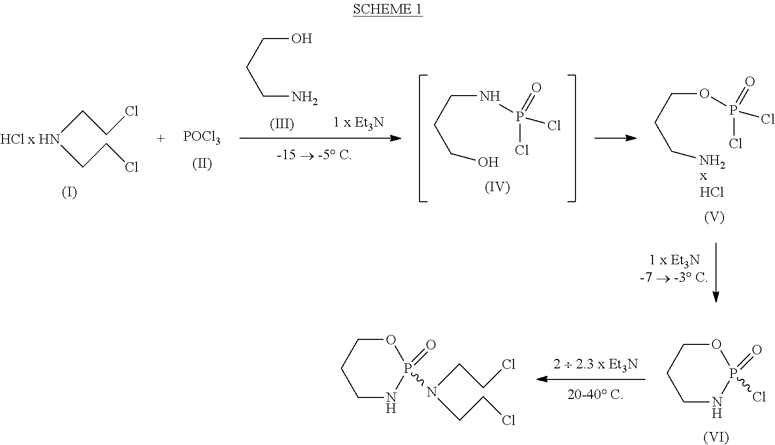

Without going into the detailed mechanism of the process, it can be assumed that at the first step, due to the protection of bis(2-chloroethyl)amine (I) in the form of hydrochloride and reduced amount of the auxiliary base present in the reaction medium in relation to the 3-aminopropan-1-ol (III) added, in acidic environment there occurs the reaction of substitution of the chlorine atom in the phosphorous oxychloride (II) with the hydroxyl group of 3-aminopropan-1-ol (III). The result of this thermodynamically controlled reaction is a dichlorophosphate monoester (V), stable in acidic conditions. This step is conducted in low temperature, in the range of −15 to −5° C., preferably from −12 to −8° C. The use of bis(2-chloroethyl)amine in the form of hydrochloride results in it not showing reactivity in the reaction mixture until it is released with one mole of the auxiliary base and the last portion of the auxiliary base in the amount no less than one mole is added. Furthermore, the use of bis(2-chloroethyl)amine in the form of hydrochloride prevents the formation of amido chlorophosphate (IV), due to the fact that the kinetically controlled product of the 3-aminopropan-1-ol (III) amine group attack at the POCl₃ phosphorous atom, decomposes in acidic environment back to active dichlorophosphate, 3-amino-1-O-propyl-dichlorophosphate of formula (V). As a result of the existing equilibrium, the phosphorous oxychloride present in the reaction mixture does not undergo the reaction of substitution with the 3-aminopropan-1-ol (III) amine group in these conditions, due to the instability of the phosphorous-nitrogen bond. Similarly, in the acidic conditions of the process, the substitution of N,N-bis(2-chloroethyl) amine (I) with the 3-aminopropan-1-ol (III) amine group does not occur either.

At the next step, due to the addition of another portion of the base, the dichlorophosphate monoester (V) undergoes, in temperature of from −10 to 5° C., preferably from −8 to −3° C., a thermodynamically favored cyclisation reaction to 2-chloro-tetrahydro-2H-1,3,2-oxazaphosphorine 2-oxide (VI). The formation of this product is confirmed by the analysis of the reaction mixture by means of ³¹P NMR nuclear magnetic resonance spectroscopy (CDCl₃), wherein a characteristic signal at δ=10.5 ppm is observed. Use of temperatures in the range of −10 to −5° C. allows to maintain high purity and yield of the process.

After the cyclization reaction has ended, another portion of the auxiliary base controlling the concentration of hydrochloride is added dropwise in room temperature and mixture temperature is gradually increased to 20-40° C., which results in substitution of 2-chloro-tetrahydro-2H-1,3,2-oxazaphosphorine 2-oxide (VI) with N,N-bis(2-chloroethyl)amine (I), gradually released from hydrochloride thereof.

After the process has ended, a two-phase mixture is obtained, wherein the solid hydrochloride of the auxiliary base, preferably the crystalline triethylamine hydrochloride, being a side product of the binding of released hydrochloride, is suspended in the solution of the product.

After filtering the auxiliary base hydrochloride or after removing it through water extraction, the actual reaction product is released by additionally washing the crude product solution in an organic solvent with water of pH<7 and aqueous salt solutions, preferably acidic and neutral carbonates or chlorides, including ones of sodium and potassium, and it is optionally filtered through a mixture of silica gel and aluminium oxide, washing with the solvent used for the reaction.

Subsequently, the solution is concentrated by evaporating the solvent used in the process, whereupon a different inert solvent is added, such as diisopropyl ether, dichloromethane, methyl-ethyl ketone, ethyl acetate, and particularly toluene, and both solvents are co-evaporated from the reaction mixture under reduced pressure in order to remove trace amounts of the solvent used in the process.

The obtained oleaginous product is dissolved in a solvent, such as diisopropyl ether, dichloromethane, methyl-ethyl ketone, ethyl acetate or toluene with the addition of water. A particularly preferred solvent is toluene. During cooling of the mixture to temperature of 0-5° C. crystallization of cyclophosphamide in the form of monohydrate occurs.

Using an inert solvent, such as toluene, in the process of product separation, reduces the risk of explosion, increasing the safety of the personnel handling the process in comparison to diethyl ether used thus far.

The crystalline cyclophosphamide monohydrate may be further purified, for example by means of a recrystallization method. To this end, the crude reaction product is dissolved in temperature 25-40° C. in a mixture of deionized water and ethanol, optionally with the addition of activated carbon and sodium bicarbonate. After hot filtration through a polyamide filter, the temperature is lowered to 0° C., with continuous stirring. The crystallized product is filtered, washed with cold deionized water and dried in a stream of humid air with humidity of 10% to 35% RH. Cyclophosphamide in the form of crystalline monohydrate is obtained.

Preferably, the process according to the invention is conducted in areas with controlled clean zones, in particular sterile rooms. The method of performing the process reduces the risk of the reaction mixture contacting external environment, minimizing its effect on the environment and vice versa—the mixture undergoing the reaction does not have contact with substances undesired for the process nor the possibility for cross-contamination.

The product is distributed, maintaining aseptic conditions, to sterilized glass or polymer ampoules and tightly sealed.

The product obtained in the described conditions may be administered to a patient ex tempore.

The method according to the invention is applicable for production of racemic N,N-bis(2-chloroethyl)-tetrahydro-2H-1,3,2-oxazaphosphorine-2-amine 2-oxide. The developed method allows for obtaining cyclophosphamide of high pharmaceutical-grade purity, fulfilling all requirements of the European and American Pharmacopea.

The invention is illustrated by the following example.

### EXAMPLE

In a reactor of a 1.5 l capacity, 180 ml of dry chloroform was provided and 44.4 g (0.249 mol) bis-(2-chloroethyl)amine hydrochloride was added. The obtained suspension was stirred with a magnetic stirrer and cooled to a temperature of −12° C. 22.4 ml (0.240 mol) of phosphorous oxychloride was added in one portion to the mixture and it was again cooled to a temperature of −12° C. Simultaneously, a solution of 18.1 ml of 3-aminopropan-1-ol (0.237 mol) and 33 ml of triethylamine (0.237 mol) in dry chloroform (45 ml) was prepared. The solution was added dropwise to the reactor over a period of 7 h, while maintaining the reaction temperature within the range −10±2° C. Next, over a period of 2 h 33 ml (0.237 mol) of triethylamine was added dropwise in a temperature of −5±2° C. After addition, the mixture was stirred for 15 h in room temperature, and then temperature was raised to 22° C. and 76.3 ml (0.547 mol) of triethylamine was added dropwise over a period of 4 h, while maintaining the temperature of 22-28° C. The whole mixture was stirred for 18 h in temperature of 28-31° C. The post-reaction mixture was cold washed (0-4° C.) with a solution of diluted hydrochloric acid (2.2 ml of concentrated HCl in 80 ml of water, first wash) and second wash was performed, also with diluted hydrochloric acid (2.2 ml and 40 ml of water), then with water (30 ml), with a potassium bicarbonate solution (2 g of salt in 20 ml of water) and finally with brine (4 g of salt in 20 ml of water). The organic phase was dried over a mixture of 2.5 g of magnesium sulfate and 0.5 g of sodium carbonate, then filtered through a layer of silica gel (9.34 g), the layer washed with 32 ml of dry chloroform. The chloroform solution was condensed to a consistency of a thick oil, 20 ml of toluene were added, the condensation was repeated with 20 ml of toluene, the resulting oil was dissolved in toluene (85 ml) and 15 ml of water were added. Crystallization was performed by lowering the temperature to 0° C. The product was filtered on a Schott funnel, washed twice with cold toluene (2×4.5 ml), dried in a flow of humid air. It was washed again, thrice with cold water (in the following order: 17, 6 and 6 ml) and dried in a flow of humid air. 46.8 g of a lightly yellow crystalline product were obtained (yield 71%). ³¹P NMR (D₂O), δ=15.4 ppm.

The obtained product was recrystallized. To this end, 46.75 g (0.1675 mol) of the cyclophosphamide separated from the synthesis was dissolved in a mixture of 103 ml deionized water and 17 ml ethanol, in a temperature of 34° C. 0.94 g of activated carbon and 122 mg of sodium bicarbonate were added and stirred in an evaporator, in a temperature of 34-37° C. for 10 minutes. The mixture was hot filtered through a polyamide filter (0.45 μm/0.22 μm) to a 250 ml flask by means of. The solution was crystallized, while stirring and lowering the temperature to 0° C. for 0.5 h. The product was filtered on a Schott funnel, washed with 3×7 ml of cold deionized water, dried in a stream of humid air. 40.1 g of cyclophosphamide monohydrate were obtained, with a purity fulfilling the requirements of EP and USP Pharmacopea. The yield of the recrystallization process was 86%. ³¹P NMR (D₂O), δ=15.4 ppm.

1. A method of production of N,N-bis(2-chloroethyl)amino)-2-oxo-1,3,2-oxazaphosphorinane in a reaction of phosphorous oxychloride POCl₃, N,N-bis(2-chloroethyl)amine, and 3-aminopropan-1-ol in a single reaction vessel, characterized in that phosphorous oxychloride and N,N-bis(2-chloroethyl)amine hydrochloride are added to an inert aprotic organic solvent placed in a closed reaction vessel, in a slight molar excess in relation to phosphorous oxychloride, whereupon the mixture is cooled to temperature in the range of −15 to −10° C., and with the temperature maintained within this range and continuous stirring, the solution of 3-aminopropan-1-ol and the first portion of the auxiliary base is slowly added in an amount of 1 mole calculated as per 1 mole of 3-aminopropan-1-ol in an inert aprotic organic solvent, and subsequently, while maintaining the reaction mixture temperature in the range of −7 to −3° C. the second portion of the auxiliary base is added slowly, in an amount required for binding of HCl released during the cyclisation reaction, and after the mixture reaches temperature in the range of 15 to 20° C. it is stirred in this temperature for a period of 5 to 25 hours, whereupon, while continuously stirring, the remaining portion of the auxiliary base is added slowly, in an amount of 2-2.3 moles, calculated per a theoretical amount of hydrochloride released from bis(2-chloroethyl)amine hydrochloride and released in the reaction of substitution of chlorine at the phosphorous atom in 2-chloro-tetrahydro-2H-1,3,2-oxazaphosphorine 2-oxide, and without stopping the stir, the temperature is gradually increased from 20 to 40° C., the reaction being conducted until the conversion of the substrates.

2. The method according to claim 1, characterized in that the molar excess of N,N-bis(2-chloroethyl)amine hydrochloride in relation to phosphorous oxychloride is 1.01 to 1.05.

3. The method according to claim 1, characterized in that the auxiliary base is an aromatic or aliphatic tertiary amine.

4. The method according to claim 3, characterized in that the auxiliary base is triethylamine.

5. The method according to claim 1, characterized in that the organic solvent is chloroform.

6. The method according to claim 1, characterized in that the reaction product is separated by washing the organic solution of the crude product with acidified water of pH<7 and with aqueous salt solutions, preferably acidic and neutral carbonates or chlorides, including ones of sodium and potassium.

7. The method according to claim 1, characterized in that toluene is added to a crude product solution in the organic solvent used in the reaction, and it is evaporated together with the solvent, and the obtained oleaginous product is dissolved in toluene and water is added, obtaining a crystallized product.

8. The method according to claim 1, characterized in that the product is obtained in a monohydrate form.

9. The method according to claim 1, characterized in that the product is further purified by recrystallization.

10. The method according to claim 9, characterized in that the product is purified by recrystallization in a mixture of deionized water and ethanol.

11. The method according to claim 1, characterized in that the product of a pharmacopoeial purity is obtained.

12. The method according to claim 1, characterized in that the product is distributed in aseptic conditions, to sterilized glass or polymer ampoules and tightly sealed.
